(19) United States
(12) Patent Application Publication
(10) Pub. No.: US 2018/0252392 A1
(43) Pub. Date: Sep. 6, 2018

(54) Quick Connect Light Bulb

(71) Applicant: Juan Ortiz, Pembroke Pines, FL (US)

(72) Inventor: Juan Ortiz, Pembroke Pines, FL (US)

(21) Appl. No.: 15/909,995

(22) Filed: Mar. 1, 2018

Related U.S. Application Data
(60) Provisional application No. 62/465,295, filed on Mar. 1, 2017.

(51) Int. Cl. F21V 19/00

(52) U.S. Cl. CPC F21V 19/004; F21V 23/06; F21V 19/0075; F21V 19/0005

(57) ABSTRACT

A “push-in” or “quick-connect” light bulb provides for at least one spring-loaded metal tabs built into the bulb's base that are configured to retract when a user pushes the light bulb into a light socket, thereby allowing an electrical connection to be made between the light bulb's base and the light socket. In some embodiments, the one or more metal tabs, the bulb's base, or both the metal tab(s) and the bulb's base are configured to conduct electricity from the socket to the present invention's filament or other illumination element.

### CROSS-REFERENCE TO RELATED APPLICATION

This application claims priority to U.S. Provisional Application No. 62/465,295 filed on Mar. 1, 2017, the disclosure of which, including any materials incorporated by reference therein, is incorporated herein by reference in its entirety.

### TECHNICAL FIELD

The present invention relates generally to the field of light bulbs and more specifically relates to a push-in light bulb.

### BACKGROUND

A light bulb is a necessity item in all homes, as it provides light inside the home without the requirement of lighting candles. Light bulbs are usually simple to install and use. They are normally screwed into light sockets in various kinds of light fixtures and lamps, and are normally removed by unscrewing them when they need to be replaced. Unfortunately, the process of screwing a light bulb into a socket or unscrewing it can be problematic in several circumstances.

One such circumstance is when the light bulb becomes damaged. Sometimes, the glass part of the bulb separates from its metal base, which makes it difficult to remove. When this happens, a person may need to shut off power to the bulb and its fixture, then use needle-nose pliers to loosen the base. It may still be very difficult to work the base loose without being showered by bits of broken glass from the bulb. This is a common occurrence when having to replace burned-out bulbs in ceiling lights, ceiling fan fixtures, or light bulbs that have been in place for a long period of time.

Another such circumstance occurs when a light socket has been installed in such a way as to make the many turns of screwing in a light bulb laborious. These could be light sockets that are high enough off the ground that a person must reach as far as she or he is able to insert the light bulb, and then hold her or his arm there for the many turns required to fully insert the light bulb. Or, the light socket could be at an odd angle that requires a person to contort her or his hand to get the light bulb in place. In such an instance, the person may end up dropping the light bulb before making the many necessary turns, thereby likely breaking the light bulb in the process.

Attempts have been made, although unsuccessfully, to solve this problem. One illustrative attempt can be seen with respect to U.S. Pat. No. 4,824,393, incorporated by reference in its entirety herein, which generally discloses a push-in lightbulb system, wherein the bulb lays on its side and several modified conducing elements stretch from the base to the bulb. Although this disclosure does provide for a push-in lightbulb system, its sideways and exposed design limits its utility in today's houses.

Another attempt can be seen with respect to U.S. Pat. No. 7,413,456 incorporated by reference in its entirety herein, which generally discloses a push-in electrical socket that accepts standard-format light bulbs. While this disclosure does allow for a push-in type connection, this disclosure is limited by modifying the socket rather than the bulb.

Still another attempt can be seen with respect to U.S. Pat. No. 5,800,212, incorporated by reference in its entirety herein, which generally discloses a unique push-in light bulb base and a specially designed electrical socket to match. While this disclosure does provide for a sophisticated push-in bulb and socket system, by requiring that the socket and the bulb's base be specially designed for each other, this disclosure's widespread utility is minimal.

What is needed is a push-in light bulb that fits into traditional sockets with a greater ease of connectivity than normal light bulb. Therefore, a need exists for a unique and more effective push-in light bulb.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed in the present disclosure by name, such as a light bulb (or lightbulb), metal threads, base, glass, filament, electrical socket (or simply “socket”) and so forth, are herein meant to include or encompass all equivalents for such elements. For example, in addition to a “bulb”, any bulb, rod, or cone shape is contemplated for any illuminating element in connection with the present invention. Such equivalents are contemplated for each element named in its particular herein.

The present invention relates to a push-in light bulb that overcomes the deficiencies of the prior art. It is contemplated that the present invention may provide an easily installed push-in light bulb that can work in any socket.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel push-in light bulb. The general purpose of the present invention, which shall be described subsequently in greater detail, is to allow a user to insert and connect a light bulb into a light socket without having to twist the light bulb into place. The features of the invention are believed to be novel and to have been particularly pointed out and distinctly claimed in the concluding portion of the specification. These and other features, aspects, and advantages of the present invention will become better understood with reference to the following drawing and detailed description.

The present invention may, in some embodiments, comprise a quick-connect light bulb. In such embodiments, the present invention may provide for a light bulb having a metal base, similar in size and style to conventional bulbs used in lamps and light fixtures worldwide. However, in some embodiments, the base on the present invention may not be threaded. It may instead provide for one or more spring-loaded tabs that may be designed to make it easy to insert the present invention in a socket and to remove it without having to screw it in or out. In some embodiments, the spring-loaded tabs may be configured to conduct electricity, the metal base may be configured to conduct electricity, or both. In some embodiments, the present invention may be configured such that when a user may push the base of the present invention into a traditional electrical socket, the tabs may retract so as to accommodate the socket's walls while also keeping a tight connection between the base and the socket. Once inserted, the present invention may conduct electricity from the socket to the present invention's interior, where one or more filaments or other illumination elements may emit light in response to stimulation from the conducted electricity.

The present invention is designed for universal use and it is contemplated that the present invention will fit into the same light fixtures and lamps that use conventional light bulbs. One of the present invention's distinguishing features is the design of its metal base. The present invention's metal base has four spring-loaded tabs that are used to secure the bulb in a socket rather than threads for screwing it in and out. The tabs allow the wires in the bulb to make a tight contact with the power supply, so the present invention may function in the same way as a conventional bulb. The present invention may be centered over the socket and locked into a secure position by pushing it into place. It may be removed as quickly and as easily when it needs to be replaced. The present invention may be available in the same sizes, styles, and types as conventional bulbs, and the tabs around the metal bases may allow them to be used in any type of light fixture that takes a screwable' bulb.

The unique features of the present invention may provide the following benefits for one or more consumers: it may prevent be easier and quicker to insert and to remove than other light bulbs; its spring-loaded tabs may effectively secure the bulb to the socket, enabling the present invention to make contact with the power supply without needing to be twisted; and the present invention may make replacing bulbs in hard-to-reach sockets, such as by way of example in ceiling fan light sockets, much easier as well.

### BRIEF DESCRIPTION OF THE DRAWINGS

These and other features, aspects and advantages of the present invention will become better understood with regard to the following description, appended claims, and accompanying figures where:

FIG. 1 shows a front perspective view of a quick connect light bulb in accordance with an embodiment of the invention.

FIG. 2 shows a zoomed-in perspective view of a quick connect light bulb in accordance with an embodiment of the invention.

FIG. 3 shows a side by side top-perspective and bottom-perspective view of a quick connect light bulb in accordance with an embodiment of the invention.

### DETAILED DESCRIPTION

The present invention overcomes the limitations of the prior art by providing a new and more effective quick connect light bulb.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising,” “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known features, elements or techniques may not be shown in detail in order not to obscure the embodiments.

In some embodiments, the present invention may comprise a quick connect light bulb that has at least one base with at least one side surface, at least one cavity, at least one upper side, and at least one bottom portion. The at least one base may be fixedly connected to, or one piece with, at least one base connection. The at least one base connection may be configured to removably mate with and electrically couple with at least one light socket. The present invention may also provide for at least one bulb portion connected to and extending from the at least one upper side, wherein the at least one bulb portion has at least one transparent portion and at least one illuminating element inside the at least one bulb portion, wherein the at least one illuminating element is configured to shine light through the at least one transparent portion. Furthermore, the present invention may provide for at least one spring loaded tab, wherein the at least one spring loaded tab may be configured to retractably extend out of the at least one cavity, and wherein the at least one spring loaded tab is configured to retract when the at least one base is inserted into at least one light socket, wherein the retraction of the at least one spring loaded tab is configured to provide a removable connection between the at least one base and the at least one light socket. This orientation may cause the at least one base to be in a removable connection with the at least one light socket, and therefore to enable the at least one base to conduct electricity via at least one conduit from the at least one light socket to the at least one illuminating element.

In some embodiments, the at least one base connection may provide the point of electrical coupling between the at least one base and the at least one light socket. In some embodiments, the at least one spring loaded tab is configured to conduct electricity into the at least one conduit. Furthermore, in some embodiments, the at least one bulb portion is configured as an incandescent light bulb. In some embodiments, the at least one bulb portion is configured as a fluorescent light bulb, a compact fluorescent light bulb, a halogen light bulb, and/or at least one illumination element is at least one LED. Additionally, in some embodiments, the at least one base my provide for at least two cavities and at least two spring loaded tabs extending therethrough, at least three cavities and at least three spring loaded tabs extending therethrough, and/or at least four cavities and at least four spring loaded tabs extending therethrough. Moreover, in some embodiments, the at least one base connection may be conical, and/or shaped as one or more plug-shaped protrusions. It is contemplated that the plug shapes may be any known in the art. And, in some embodiments, the at least one base may cylindrical, and in some similar embodiments, the base's at least one side surface may provide for one or more grooves.

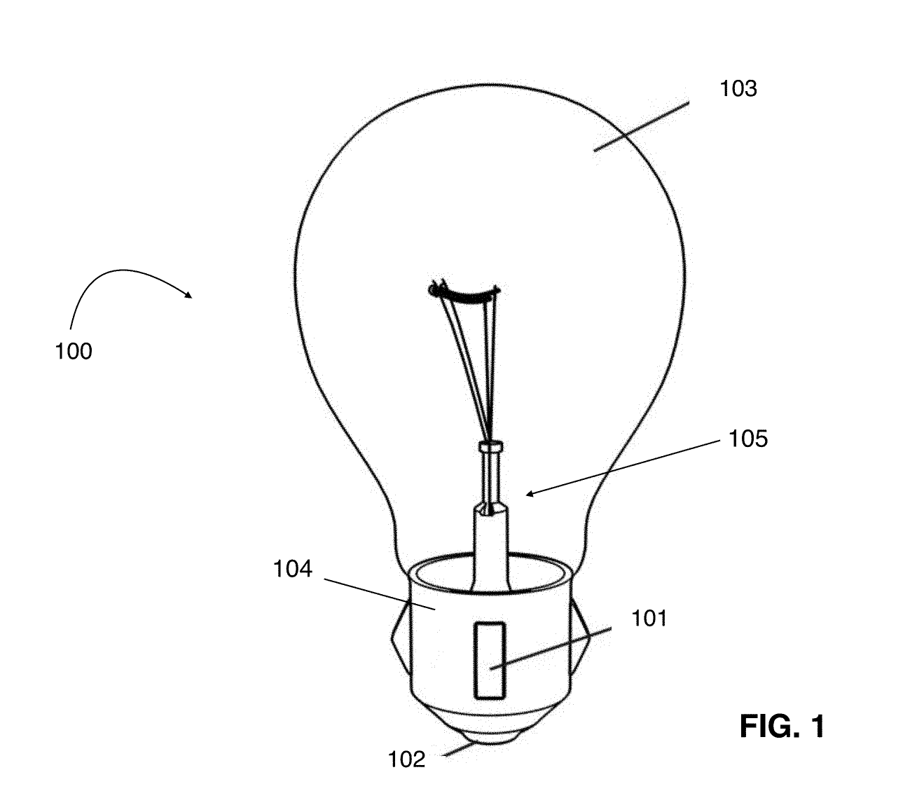

Turning attention to FIG. 1, a front perspective view of a quick connect light bulb in accordance with an embodiment of the invention is shown. In the embodiment depicted, a viewer may perceive quick connect light bulb 100, spring loaded tab 101, base connection 102, bulb 103, and base 104.

In some embodiments, it is contemplated that spring-loaded tab 101 may be metal, and may be fixedly connected to at least one metal spring inside of base 104. In other embodiments, spring-loaded tab 101 may be made of another electricity-conducting material, or a non-conductive material such as a plastic.

It is contemplated that base connection 102 may, in some embodiments, present one of the at least one points of electrical connection between quick connect light bulb 100 and a light bulb socket (not pictured). In some embodiments, at least one of spring loaded tab 101, base connection 102, and base 104 may conduct electricity.

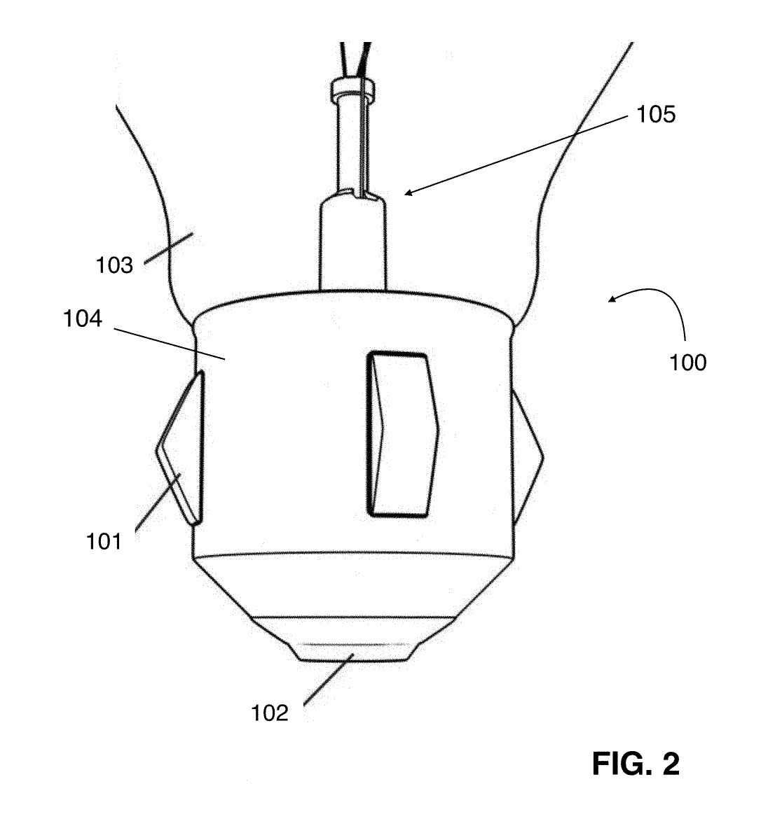

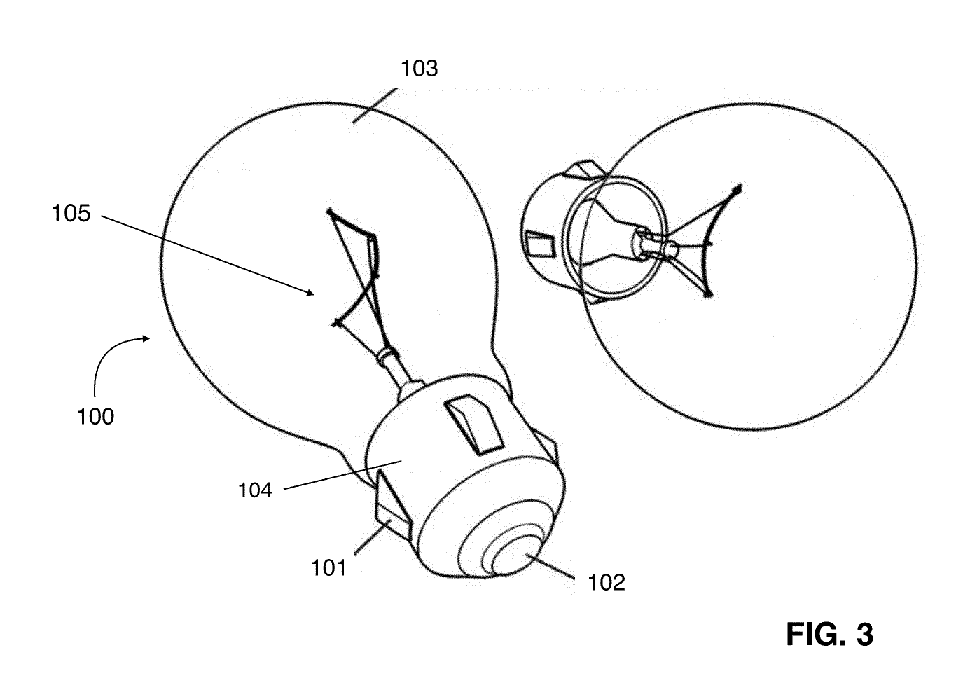

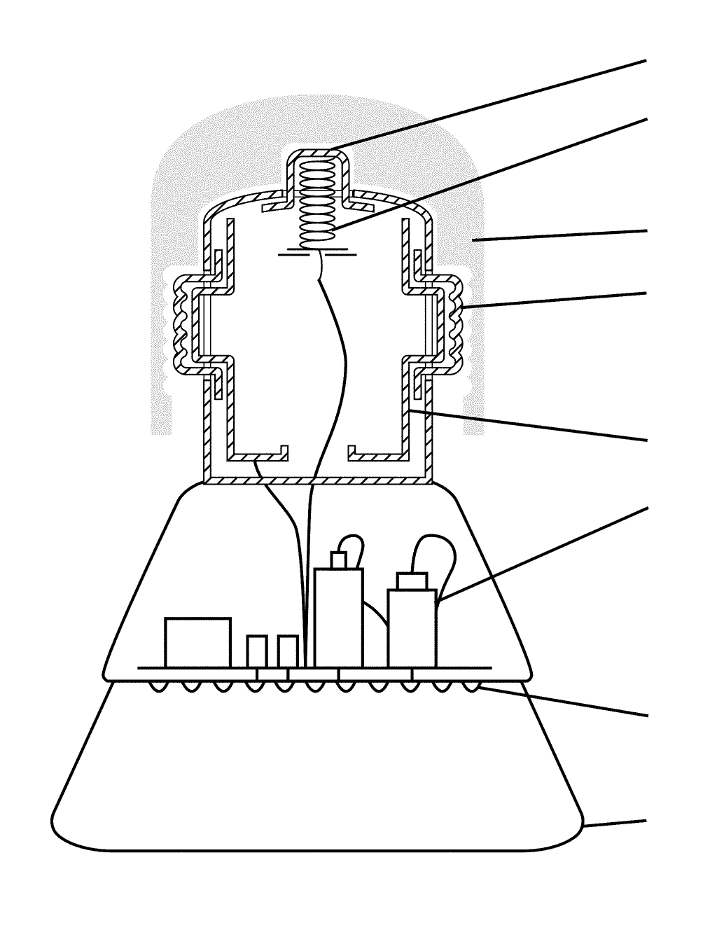

It is contemplated that bulb 103 may be of any size or shape known in the art. By way of illustration and not limitation, bulb 103 may be bulbous, as shown in FIG. 1, FIG. 2, and FIG. 3. In other embodiments, bulb 103 may be cylindrical, spear shaped, pill-shaped, shaped as a star or other fanciful shape, shaped as a letter or a face, and so forth. Any shape is contemplated. Additionally, bulb 103 may be as small as a miniature light bulb or of large industrial size. To any practicable extent, as well, spring loaded tab 101, base connection 102, and base 104 may also be of any size or shape known in the art.

It is also contemplated that quick connect light bulb 100 may be of any type of light bulb, including but not limited to, an incandescent light bulb, a light bulb having one or more light-emitting diodes (LED's), a fluorescent light bulb, a compact fluorescent light bulb, a halogen light bulb, a floodlight, any configuration of a LED lightbulb, such as but not limited to an edge-lit bulb having a light guide, and any other type, shape, or form of lightbulb capable of practice with the present invention or otherwise known in the art.

With respect to FIG. 2, a zoomed-in perspective view of a quick connect light bulb in accordance with an embodiment of the invention is shown. In the embodiment depicted, a viewer may perceive quick connect light bulb 100, spring loaded tab 101, base connection 102, bulb 103, and base 104. In FIG. 2, a viewer may perceive more detail regarding the contours of quick connect light bulb 100, particularly with respect to base connection 102. As any of the elements of quick connect light bulb 100, including but not limited to spring loaded tab 101, base connection 102, bulb 103, and base 104, the shapes and sizes of said elements are not limited to the embodiment depicted in FIG. 2.

With respect to FIG. 3, a side by side top-perspective and bottom-perspective view of a quick connect light bulb in accordance with an embodiment of the invention is shown. In the embodiment depicted, a viewer may perceive quick connect light bulb 100, spring loaded tab 101, base connection 102, bulb 103, and base 104. FIG. 3 provides more detail concerning the present invention, particularly with respect to bulb 103. As mentioned previously, quick connect light bulb 100, and bulb 103 may take any shape known in the art. Hence, the bulbous nature of bulb 103 as depicted in FIG. 3 may vary in alternative embodiments, along with the interior portions of bulb 103, which are shown in FIG. 3 for purely illustrative purposes.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the quick connect light bulb generally described herein has been disclosed in connection with a number of embodiments shown and described in detail, various modifications should be readily apparent to those of skill in the art.

What is claimed is:

1. A quick connect light bulb, comprising:
at least one base, the at least one base having at least one side surface, at least one cavity, at least one upper side; and at least one bottom portion;
at least one base connection, wherein the at least one base connection is fixedly connected to the at least one bottom portion;
at least one bulb portion, wherein the at least one bulb portion extends from the at least one upper side, wherein the at least one bulb portion comprises:
at least one transparent portion; and
at least one illuminating element inside the at least one bulb portion, wherein the at least one illuminating element is configured to shine light through the at least one transparent portion; and
at least one spring loaded tab, wherein the at least one spring loaded tab is configured to retractably extend out of the at least one cavity, and wherein the at least one spring loaded tab is configured to retract when the at least one base is inserted into at least one light socket, wherein the retraction of the at least one spring loaded tab is configured to provide a removable connection between the at least one base and the at least one light socket, and wherein when the at least one base is in a removable connection with the at least one light socket, the at least one base is configured to conduct electricity via at least one conduit from the at least one light socket to the at least one illuminating element.

2. The quick connect light bulb of claim 1, wherein the at least one base connection provides the point of electrical coupling between the at least one base and the at least one light socket.

3. The quick connect light bulb of claim 1, wherein the at least one spring loaded tab is configured to conduct electricity into the at least one conduit.

4. The quick connect light bulb of claim 1, wherein the at least one bulb portion is configured as an incandescent light bulb.

5. The quick connect light bulb of claim 1, wherein the at least one bulb portion is configured as a fluorescent light bulb.

6. The quick connect light bulb of claim 1, wherein the at least one bulb portion is configured as a compact fluorescent light bulb.

7. The quick connect light bulb of claim 1, wherein the at least one bulb portion is configured as a halogen light bulb.

8. The quick connect light bulb of claim 1, wherein the at least one illumination element is at least one LED.

9. The quick connect light bulb of claim 1, the at least one base comprising at least two cavities and at least two spring loaded tabs extending therethrough.

10. The quick connect light bulb of claim 1, the at least one base comprising at least three cavities and at least three spring loaded tabs extending therethrough.

11. The quick connect light bulb of claim 1, the at least one base comprising at least four cavities and at least four spring loaded tabs extending therethrough.

12. The quick connect light bulb of claim 1, wherein the at least one base connection is conical.

13. The quick connect light bulb of claim 1, wherein the at least one base connection is shaped as one or more plug-shaped protrusions.

14. The quick connect light bulb of claim 1, wherein the at least one base is cylindrical.

15. The quick connect light bulb of claim 14, wherein the at least one side surface has one or more grooves.
